(19) United States
(12) Patent Application Publication
(10) Pub. No.: US 2012/0104261 A1
(43) Pub. Date: May 3, 2012

(54) FUEL ASSEMBLY RADIATION MEASURING APPARATUS AND METHOD OF MEASURING RADIATION OF FUEL ASSEMBLY

(75) Inventors: Hiroshi Kitaguchi, Naka (JP); Takahiro Tadokoro, Hitachi (JP); Katsunori Ueno, Hitachi (JP); Yutaka Iwata, Hitachi (JP); Ryusuke Kimura, Hitachi (JP)

(73) Assignee: Hitachi-GE Nuclear Energy, Ltd.

(21) Appl. No.: 13/280,372

(22) Filed: Oct. 25, 2011

(30) Foreign Application Priority Data
Oct. 29, 2010 (JP) 2010-243351

(51) Int. Cl. G01T 1/208

(52) U.S. Cl. 250/362; 250/369; 250/366

(57) ABSTRACT

A fuel assembly radiation measuring apparatus has a radiation signal generation apparatus including a LaBr₃(Ce) scintillator, an A/D converter, a signal processing apparatus, and a data analysis apparatus. The signal processing apparatus has a FPGA and a CPU. γ rays emitted from a fuel assembly disposed in water in a fuel pool enter into the LaBr₃(Ce) scintillator that emits scintillator light, then a photomultiplier tube converts the light into an electric signal as a radiation detection signal. A pulse height analyzer of the FPGA inputs a radiation detection signal having a digital waveform generated by the A/D converter and changes the digital waveform into a trapezoid waveform to obtain a maximum peak value. The data analysis apparatus quantifies a target nuclide using a plurality of inputted maximum peak values to obtain burnup.

### CLAIM OF PRIORITY

The present application claims priority from Japanese Patent application serial no. 2010-243351, filed on Oct. 29, 2010, the content of which is hereby incorporated by reference into this application.

### BACKGROUND OF THE INVENTION

1. Technical Field

The present invention relates to a fuel assembly radiation measuring apparatus and a method of measuring radiation of fuel assembly and more particularly to a fuel assembly radiation measuring apparatus and a method of measuring radiation of fuel assembly suitable for measuring the radiation (for example, γ rays) emitted from a spent fuel assembly that was taken out from a core in a reactor.

2. Background Art

Conventionally in a nuclear power plant, spent fuel assemblies are taken out from a reactor after shutdown of reactor operation in one operation cycle and radiation of the spent fuel assemblies is measured. This radiation measurement is also referred to as a γ scan measurement operation. In addition, burnup and power distribution of the spent fuel assembly are obtained based on measurement values of the radiation. The radiation measurement of the spent fuel assembly is necessary for comparing the measurements with calculation results of the core nuclear design for evaluation. Furthermore, the radiation measurement is an important operation for assuring reactor safety and burning of the fuel assembly and for inspecting management of the reactor operation. In addition, this radiation measurement of the spent fuel assembly is an important technology for burnup checking in order to ensure criticality safety performed when the spent fuel assemblies are transported to a reprocessing facility and received into the reprocessing facility.

Many conventional fuel assembly radiation measuring apparatuses use a NaI(T1) detector that measures γ rays emitted from a fuel assembly. One example of the conventional fuel assembly radiation measuring apparatuses is described in Japanese Patent Laid-open No. 10 (1998)-239439. A spent fuel assembly taken out from a reactor is stored and kept in a fuel storage rack provided in a fuel storage pool filled with cooling water. The spent fuel assembly stored in the fuel storage rack is taken out from it and set to a fuel assembly moving apparatus (fuel preparation machine). The radiation emitted from the spent fuel assembly set to the fuel assembly moving apparatus is measured by a radiation detection apparatus hung from a hoisting and lowering apparatus. The radiation detection apparatus is provided with the NaI(T1) detector, which is a scintillator, and a collimator in its casing. The collimator is disposed on the front surface of the NaI(T1) detector to selectively allow the radiation emitted from a partial region (an attention area (node) of the fuel assembly) in the axial direction of the fuel assembly to enter into the NaI(T1) detector; the fuel assembly is a measurement object. An absorber for adjusting the amount of radiation entering into the NaI(T1) detector is disposed on a front surface of the collimator, and the NaI(T1) detector is surrounded by a radiation shield.

Japanese Patent Laid-open No. 6 (1994)-160585, Japanese Patent Laid-open No. 10 (1998)-39085, Japanese Patent Laid-open No. 10 (1998)-239439, and Japanese Patent Laid-open No. 2000-221293 describe a fuel assembly radiation measuring apparatus which uses a semiconductor radiation detector such as a CdTe semiconductor detector and a Ge(Li) semiconductor detector in order to improve energy resolving power (performance of discriminating γ rays' energy (performance of analyzing radioactive nuclides)) when γ rays emitted from a fuel assembly are measured.

Furthermore, some examples of a fuel assembly radiation measuring apparatus having a plurality of radiation detectors to improve efficiency in the radiation measuring operation of a fuel assembly are described in Japanese Patent Laid-open No. 7 (1995)-306291, Japanese Patent Laid-open No. 9 (1997)-251092, Japanese Patent Laid-open No. 10 (1998)-39085, and Japanese Patent Laid-open No. 10 (1998)-90472.

### CITATION LIST

### Patent Literature

[Patent Literature 1] Japanese Patent Laid-open No. 6 (1994)-160585
[Patent Literature 2] Japanese Patent Laid-open No. 7 (1995)-306291
[Patent Literature 3] Japanese Patent Laid-open No. 9 (1997)-251092
[Patent Literature 4] Japanese Patent Laid-open No. 10 (1998)-39085
[Patent Literature 5] Japanese Patent Laid-open No. 10 (1998)-90472
[Patent Literature 6] Japanese Patent Laid-open No. 10 (1998)-239439
[Patent Literature 7] Japanese Patent Laid-open No. 2000-221293

### SUMMARY OF THE INVENTION

### Technical Problem

Conventionally, a fuel assembly radiation measuring apparatus having a generally used NaI(T1) detector (Japanese Patent Laid-open No. 10 (1998)-239439) uses an analog measurement circuit which has a low maximum counting rate of 10 kcps or less, thus it is difficult to further shorten the time of radiation measurement.

The fuel assembly immediately after the shutdown of reactor operation is extremely strong in radiation intensity, which saturates the detection performance (the maximum counting rate) of a normal radiation detector and makes the detector difficult to operate normally. The extent of difficulty in normal operation is determined by processing time necessary from the entry of a single ray of radiation to the detection of the next ray of radiation (dead time). The processing time (dead time) is determined by a pulse width (a waveform width) of radiation measurements necessary for radiation energy analysis. The processing time (dead time) corresponds to decay time of scintillation light when a scintillation detector is used, and to charge (electron or hole) collection time when a semiconductor radiation detector is used. Therefore, in order to reduce the amount of radiation entry, a conventional radiation detector was required some kind of geometric system for measurement such as extending the distance between a radiation detector and a fuel assembly that is a measurement object or dramatically limiting the amount of radiation entry using a collimator. This is closely related to the time required for measuring the fuel assembly, and a fuel assembly radiation measuring apparatus using a conventional radiation detector was required a long measurement time for obtaining radiation count values that are necessary for calculating burnup and power distribution.

The fuel assembly radiation measuring apparatuses described in Japanese Patent Laid-open No. 6 (1994)-160585, Japanese Patent Laid-open No. 10 (1998)-39085, Japanese Patent Laid-open No. 10 (1998)-239439, and Japanese Patent Laid-open No. 2000-221293 use a semiconductor radiator such as a CdTe radiation detector and a Ge(Li) radiation detector. Unfortunately, the CdTe radiation detector loses its stability in radiation detection performance due to the occurrence of a polarization phenomenon during long time use, and also, it does not allow the production of a radiation detector having a large sensitive volume (a high-sensitive radiation detector). Furthermore, the Ge(Li) radiation detector must be cooled to nearly a liquid nitrogen temperature (−196° C.), and its cost is extremely high. It is difficult for these semiconductor radiation detectors also to further shorten the time of radiation measurement due to a limit in a maximum counting rate.

A reduction in the operation time of measuring the radiation of a fuel assembly (y scan measurement time) leads to a reduction in a periodic inspection period of the nuclear plant, which enhances the operation rate of the nuclear plant.

In addition, the fuel assembly radiation measuring apparatus described in each of Japanese Patent Laid-open No. 7 (1995)-306291, Japanese Patent Laid-open No. 9 (1997)-251092, Japanese Patent Laid-open No. 10 (1998)-39085, and Japanese Patent Laid-open No. 10 (1998)-90472 is equipped with a plurality of radiation detectors to improve the operation efficiency of radiation measurement. However, it has a problem in practical application because there is no consideration in cost performance and the cost of the entire fuel assembly radiation measuring apparatus will be extremely high.

It is an object of the present invention to provide a fuel assembly radiation measuring apparatus and a method of measuring radiation of fuel assembly that can further shortened operation time of radiation measurement.

### Solution to Problem

The feature of the present invention for accomplishing the above object is a fuel assembly radiation measuring apparatus comprising of a radiation measuring apparatus having a collimator for limiting entry of radiation emitted from a fuel assembly, a scintillator having an emission decay time of 40 ns or less and detecting radiation passed through the collimator, a signal generation apparatus for generating a radiation detection signal that is an electric signal, based on light emitted from the scintillator by entry of the radiation, and a casing in which the collimator, scintillator and signal generation apparatus are disposed;

a signal changing apparatus for changing the radiation detection signal outputted from the signal generation apparatus into a radiation detection signal having a digital waveform;

a digital waveform processing apparatus for obtaining a maximum peak value for every radiation detection signal having a digital waveform outputted from the signal changing apparatus; and

a data analysis apparatus for quantifying a target nuclide from the plurality of maximum peak values obtained by the digital waveform processing apparatus.

The radiation detection signals generated based on the light emitted from the scintillator having an emission decay time of 40 ns or less are changed into the radiation detection signal having the digital waveform and a short pulse width, and the maximum peak value is obtained for every one of the radiation detection signals having the digital waveform in the digital waveform processing apparatus, thus, throughput can be improved and the operation time of measuring the radiation of the fuel assembly that is a measurement object can be significantly shortened. Furthermore, since the scintillator having an emission decay time of 40 ns or less is used, the time required for measuring the radiation emitted from the fuel assembly can be shortened.

Preferably, it is desirable that a digital signal processing apparatus having a waveform processing time-constant in a range of 0.5 to 8 μs is used as the digital waveform processing apparatus.

More preferably, it is desirable that a digital signal processing apparatus having a waveform processing time-constant in a range of 0.5 to 2 μs is used as the digital waveform processing apparatus.

### Advantageous Effect of the Invention

According to the present invention, the operation time of measuring the radiation of a fuel assembly can be further shortened.

### BRIEF DESCRIPTION OF THE DRAWINGS

FIG. 1 is a structural diagram showing a fuel assembly radiation measuring apparatus according to embodiment 1, which is a preferred embodiment of the present invention.

FIG. 2 is a structural diagram showing a LaBr₃(Ce) scintillation detector shown in FIG. 1.

FIG. 3 is a cross-sectional view taken along line of FIG. 1.

FIG. 4 is a detailed structural diagram showing a signal processing apparatus shown in FIG. 1.

FIG. 5 is an explanatory drawing showing processing procedures performed in the signal processing apparatus shown in FIG. 4.

FIG. 6 is an explanatory drawing showing property values of various scintillators.

FIG. 7 is an explanatory drawing showing schematically waveform processing performed in a digital signal processor shown in FIG. 4.

FIG. 8 is characteristic drawing showing a relationship between a waveform processing time-constant and throughput.

FIG. 9 is an explanatory drawing showing an analysis result of operation time required for measuring radiation of one fuel assembly using a fuel assembly radiation measuring apparatus.

FIG. 10 is a detailed structural diagram showing a signal processing apparatus used in a fuel assembly radiation measuring apparatus according to embodiment 2, which is another embodiment of the present invention.

FIG. 11 is a structural diagram showing a fuel assembly radiation measuring apparatus according to embodiment 3, which is another embodiment of the present invention.

FIG. 12 is an explanatory drawing showing relationships between the number of channels of radiation detector and a shortening ratio of radiation measuring operation time and a cost ratio of an apparatus.

FIG. 13 is an explanatory drawing showing a relationship between the number of channels of radiation detector and radiation measuring operation time.

FIG. 14 is a structural diagram showing a fuel assembly radiation measuring apparatus according to embodiment 4, which is another embodiment of the present invention.

FIG. 15 is an explanatory drawing showing an example of a spectrum measured by the LaBr₃(Ce) scintillation detector.

FIG. 16 is an explanatory drawing showing an example of a spectrum measured by a Ge(Li) radiation detector.

FIG. 17 is an explanatory drawing showing another example of a spectrum measured by the LaBr₃(Ce) scintillation detector.

FIG. 18 is a structural diagram showing a fuel assembly radiation measuring apparatus according to embodiment 5, which is another embodiment of the present invention.

### DETAILED DESCRIPTION OF THE PREFERRED EMBODIMENTS

As a fuel assembly radiation measuring apparatus, there are a fuel assembly burnup measuring apparatus and a fuel assembly power distribution measuring apparatus.

Various embodiments of the present invention will be described below with reference to the accompanying drawings.

### Embodiment 1

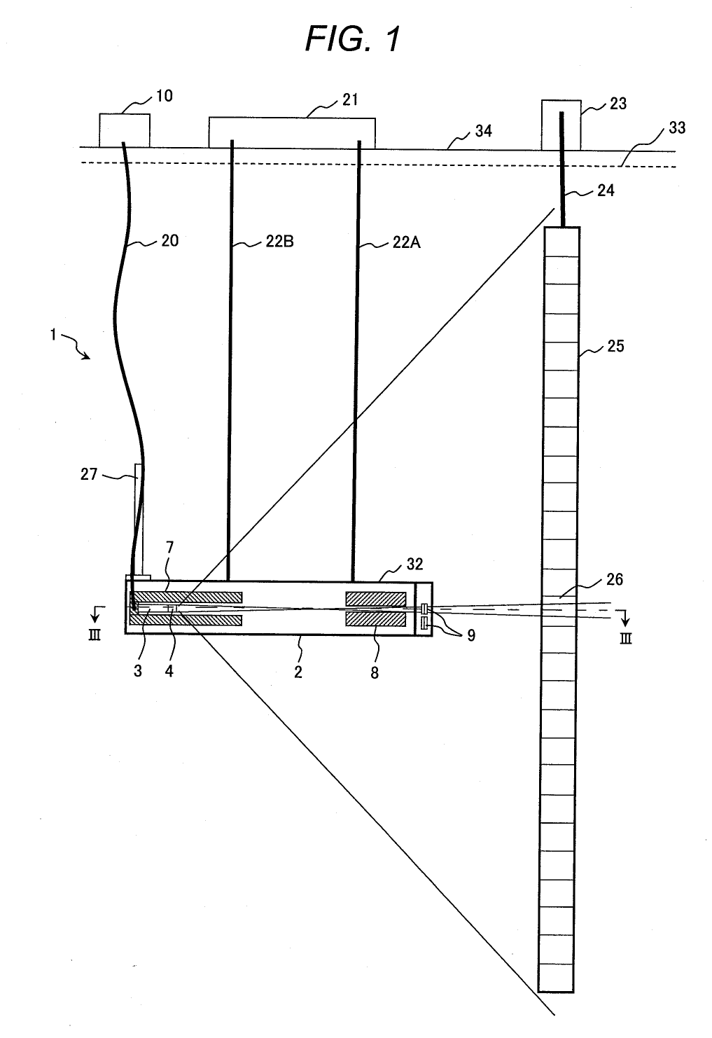

A fuel assembly radiation measuring apparatus according to embodiment 1, which is a preferred embodiment of the present invention, will be described with reference to FIGS. 1, 2, 3, and 4.

A fuel assembly radiation measuring apparatus 1 of the present embodiment is provided with a radiation measuring apparatus 2, a signal processing apparatus 10, a hoisting and lowering apparatus 21, and a fuel assembly moving apparatus (fuel preparation machine) 23. The radiation measuring apparatus 2 has a radiation signal generation apparatus 3, a post-collimator 7, a pre-collimator 8, and an absorber 9. The radiation signal generation apparatus 3, the post-collimator 7, the pre-collimator 8, and the absorber 9 are installed in a casing 32 of the radiation measuring apparatus 2. A radiation inlet (not shown) for allowing radiation such as γ rays to enter is formed in front surface of the casing 32. The absorber 9, the pre-collimator 8, and the post-collimator 7 are disposed in the casing 32 in this order in the direction away from the radiation inlet of the casing 32. The absorber 9 is disposed closest to the radiation inlet in the casing 32. The casing 32 has a structure of waterproofing. The pre-collimator 8 forms a slit penetrating itself for passing radiation. The radiation signal generation apparatus 3 is disposed inside the post-collimator 7, and a slit for passing radiation is formed in front of the radiation signal generation apparatus 3 in the post-collimator 7. The post-collimator 7 and the pre-collimator 8 are a radiation shield.

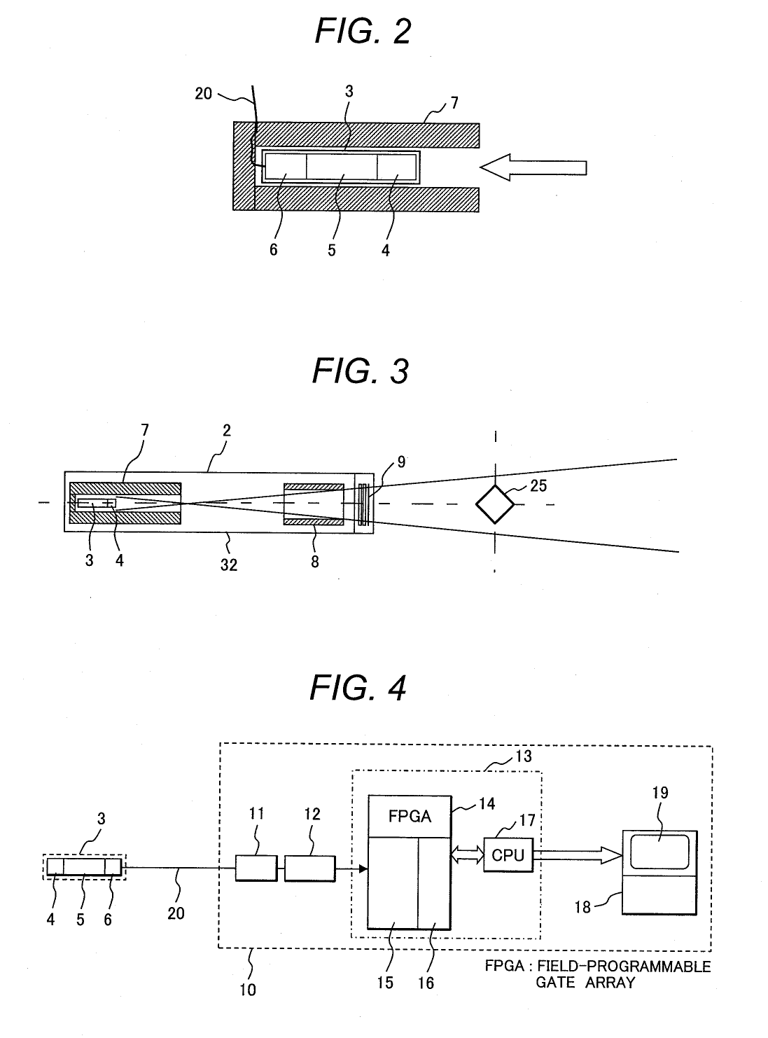

The radiation signal generation apparatus 3, as shown in FIG. 2, has a LaBr₃(Ce) scintillator (a cerium-doped lanthanum bromide scintillator) 4 as a radiation detector, a photomultiplier tube (or an avalanche photodiode) 5 that is a signal generation apparatus, and a preamplifier 6. The photomultiplier tube 5 is connected to the LaBr₃(Ce) scintillator 4, and the preamplifier 6 is connected to the photomultiplier tube 5.

The signal processing apparatus 10, as shown in FIG. 4, has a linear amplifier 11, an analog/digital converter (an A/D converter) (a signal changing apparatus) 12, a digital signal processor (a DSP circuit) 13, and a data analysis apparatus 18. The digital signal processor 13 has a field-programmable gate array (FPGA) 14 as a digital waveform processing apparatus, and a central processing unit (CPU) 17. The FPGA 14 has a pulse height analyzer 15 and a memory 16.

A fuel pool 33 is provided in a reactor building (not shown) and surrounded by an operation floor 34 formed in the reactor building. A fuel exchange apparatus (not shown) moves on operation floor 34.

The linear amplifier 11 is connected to the preamplifier 6 with a signal line 20. The signal line 20 is stored in a water seal hose 27 fixed to the casing 32. The water seal hose 27 extends above the operation floor 34. The A/D converter 12 is connected to the linear amplifier 11 and the pulse height analyzer 15. The memory 16 is connected to the pulse height analyzer 15 and the CPU 17. The data analysis apparatus 18 is connected to the CPU 17 with a cable and further connected to a display apparatus 19.

The signal processing apparatus 10, the hoisting and lowering apparatus 21, and the fuel assembly moving apparatus 23 are installed on the operation floor 34. The radiation measuring apparatus 2 is hung from the hoisting and lowering apparatus 21 with ropes 22A and 22B.

Radiation measurement of a fuel assembly 25 using the fuel assembly radiation measuring apparatus 1 will be explained. The fuel assembly (for example, a spent fuel assembly) 25, which is a measurement object, is kept in a fuel storage rack (not shown) installed in the fuel pool 33. This fuel assembly 25 is taken out from a core in a reactor pressure vessel as a spent fuel assembly, stored in the fuel storage rack in the fuel pool 33, and kept there for a predetermined period of time to be cooled by cooling water in the fuel pool 33.

When the radiation of the fuel assembly (for example, the spent fuel assembly) 25 is to be measured, the radiation measuring apparatus 2 hung from the hoisting and lowering apparatus 21 with the ropes 22A and 22B is disposed in cooling water in the fuel pool 33 in a radiation measuring area. The radiation measuring apparatus 2 is moved up and down in the fuel pool 33 by winding up or down of the ropes 22A and 22B using the hoisting and lowering apparatus 21.

The fuel assembly 25 that is the measurement object grasped by a fuel exchange apparatus (not shown), which moves on the operation floor 34, is taken out from the fuel storage rack, and transported to the radiation measuring area in the fuel pool 33 where the radiation measuring apparatus 2 is disposed using the fuel exchange apparatus. When the fuel assembly 25 reaches the radiation measuring area, it is transferred from the fuel exchange apparatus to the fuel assembly moving apparatus 23 disposed in the radiation measuring area. The fuel assembly 25 is grasped by a grasping apparatus 24 of the fuel assembly moving apparatus 23. The fuel assembly moving apparatus 23 can rotate the fuel assembly 25 and move it upward or downward. The fuel assembly 25 grasped by the fuel assembly moving apparatus 23 is facing the radiation measuring apparatus 2 in the radiation measuring area as shown in FIG. 3. In this state, the radiation inlet formed to the casing 32 is facing the fuel assembly 25. The active fuel length of the fuel assembly 25 is a length of a region in which nuclear fuel material is filled, in an axial direction of the fuel assembly. The active fuel length is divided into 24 sections in the axial direction, and each divided region is called a node.

When the radiation measuring apparatus 2 is disposed at a position which is a predetermined distance away from the fuel assembly 25 grasped by the fuel assembly moving apparatus 23 in the radiation measuring area, the height of each slit formed in the post-collimator 7 and the pre-collimator 8 is designed for the LaBr₃(Ce) scintillator 4 to come into sight the height of a node 26 of the fuel assembly 25. Additionally, the horizontal width of each slit formed in the post-collimator 7 and the pre-collimator 8 is designed for the LaBr₃(Ce) scintillator 4 to come into sight the entire width in the horizontal direction of the fuel assembly 25. The radiation of each node 26 of the fuel assembly 25 is measured by moving the fuel assembly 25 in the vertical direction one node 26 at a time using the fuel assembly moving apparatus 23 starting from the node 26 located at the bottom toward the node 26 located at the top, and while the fuel assembly 25 is rotated.

The radiation (for example, γ rays) emitted from a node of the fuel assembly 25 passes through the absorber 9 and enters into the slit of the pre-collimator 8. The absorber 9 includes a plurality of radiation attenuation plates (for example, 1 to 2 cm-thick lead plates, etc.) so that the number of radiation attenuation plates disposed in front of the slit of the pre-collimator 8 can be adjusted to fine-tune the amount of radiation entering into the slit of the pre-collimator 8. The absorber 9 may be disposed between the pre-collimator 8 and the post-collimator 7.

The radiation entered into the slit of the pre-collimator 8 passes through this slit, continuing to the slit of the post-collimator 7, and enters into the LaBr₃(Ce) scintillator 4. Only the radiation passed through the slits of the pre-collimator 8 and the post-collimator 7 enters into the LaBr₃(Ce) scintillator 4 and the other radiation is shielded by the pre-collimator 8 or the post-collimator 7. The radiation-entered LaBr₃(Ce) scintillator 4 emits scintillation light. The scintillation light is inputted into the photomultiplier tube 5 and converted into electric signals. Radiation detection signals (analog signals) that are these electric signals are amplified in the preamplifier 6, pass through the signal line 20, and are inputted into the linear amplifier 11 of the signal processing apparatus 10.

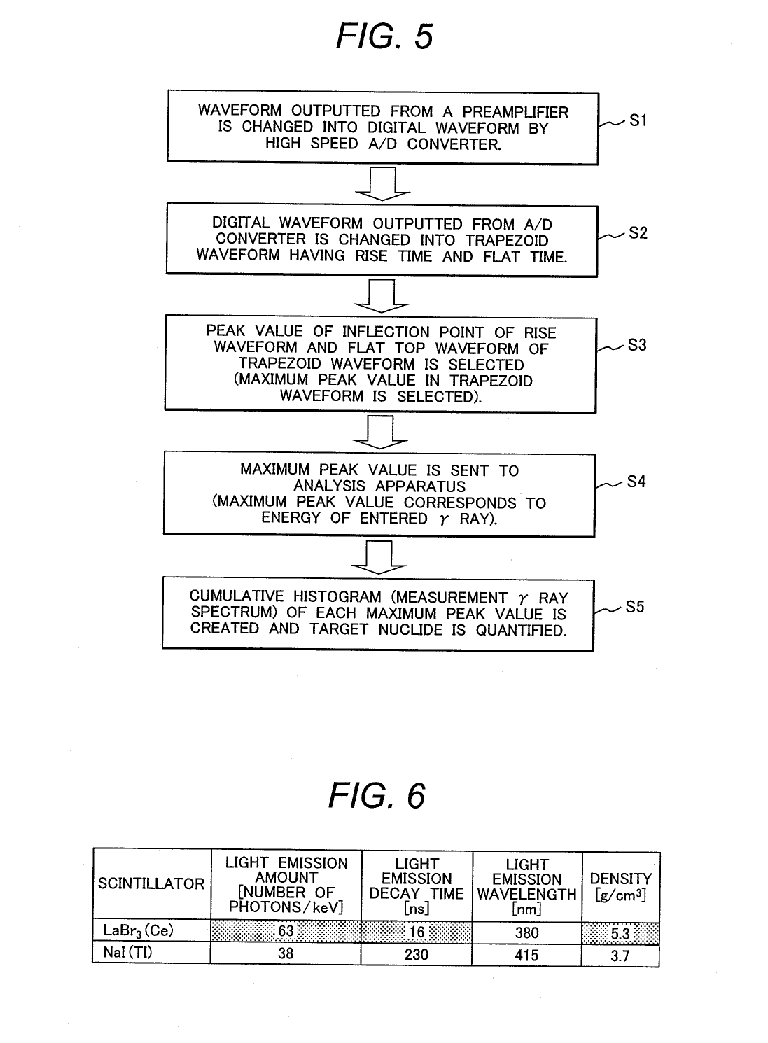

The processes performed in the signal processing apparatus 10 are specifically described with reference to FIG. 5. An output waveform from the preamplifier is changed into a digital waveform in a high-speed A/D converter (step S1). The linear amplifier 11 amplifies an inputted radiation detection signal and outputs the result into the A/D converter 12. The A/D converter 12 changes the radiation detection signal (output waveform) inputted from the linear amplifier 11 to a digital signal (digital waveform).

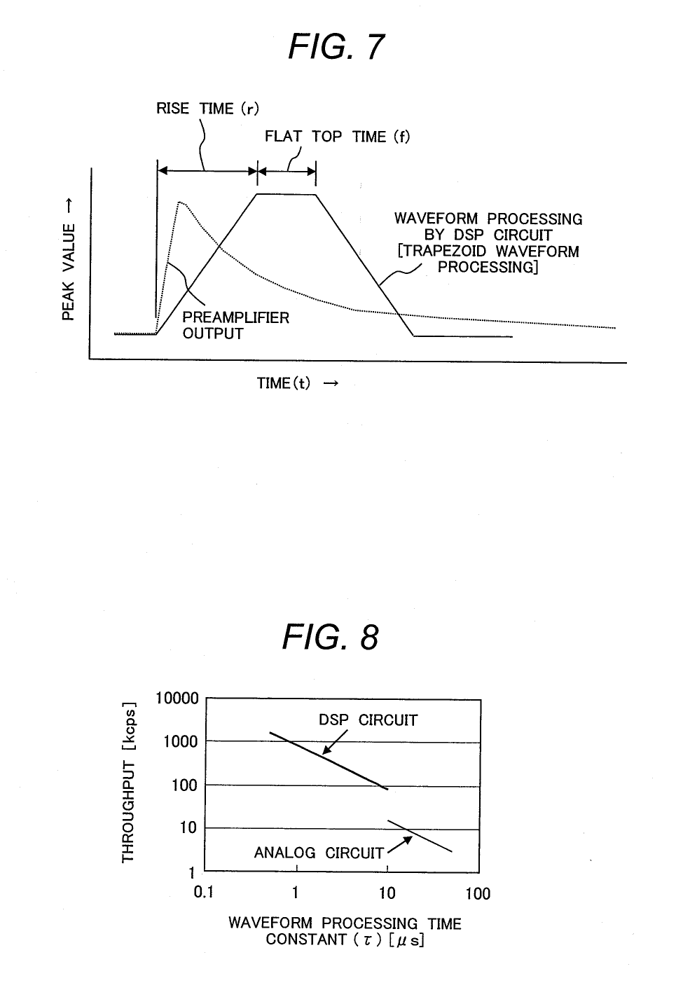

The digital waveform outputted from the A/D converter is changed into a trapezoid waveform having arise time and flat time (step S2). The radiation detection signal having a digital waveform changed into the digital signal in the A/D converter 12 is inputted into the pulse height analyzer 15 of the FPGA 14. The pulse height analyzer 15 calculates and changes the digital waveform of the inputted radiation detection signal into a trapezoid waveform having a rise time (r) and flat top time (f) as shown in FIG. 7, and obtains a digital value for each point of the trapezoid waveform. In the pulse height analyzer 15, the output of the preamplifier 6 shown in a dotted line (an analog signal of the radiation detection signal) is changed into digital values of every point of the trapezoid waveform shown in a solid line. The obtained digital values for every point of the trapezoid waveform are stored in the memory 16.

Some property values of various scintillators are shown in FIG. 6. Light emission decay time of a LaBr₃(Ce) scintillator is as short as approximately 1/14 of that of a conventional NaI(T1) scintillator, showing that the LaBr₃(Ce) scintillator is suitable for measuring a high counting rate. The density and the light emission amount of the LaBr₃(Ce) scintillator are as high as approximately 1.5 times of those of the NaI(T1) scintillator. For this reason, the LaBr₃(Ce) scintillator can achieve high-sensitive, high-resolving power radiation measurements. Comparing the actual performance of energy resolving power, the NaI(T1) scintillator shows 7 to 8% (Cs-137) while the LaBr₃(Ce) scintillator shows 3%. The energy resolving power of the LaBr₃(Ce) scintillator is significantly improved from the NaI(T1) scintillator.

In order to utilize this property, i.e. the short light emission decay time of the LaBr₃(Ce) scintillator, under the requirement of a high counting rate, the digital signal processor (DSP circuit) 13 having the FPGA 14, which is a high-speed digital waveform shaping process circuit (DSP circuit), must be applied.

When a waveform processing time constant (the duration of processing a waveform) according to the light emission decay time of the LaBr₃(Ce) scintillator is set to 20 to 30 ns, it will be possible, in principle, for digital waveform processing to achieve radiation measurement of a high counting rate of tens of Mcps. However, in such a condition, radiation pulses entering into the LaBr₃(Ce) scintillator are continuous so that the performance of energy resolving power cannot be maintained.

For this reason, as described above, the digital waveform of a radiation detection signal, which is a digital signal outputted from the A/D converter 12, is changed by calculation into a trapezoid waveform shown in FIG. 7 in the pulse height analyzer 15 of the digital signal processor (DSP circuit) 13. The output signal from the preamplifier 6 shown in a dotted line shows a waveform having fast initial rise and long decay time in ms order. The pulse height analyzer 15 rapidly changes the fast initial rise waveform and the steep decay waveform of the output signal from the preamplifier 6 into a trapezoid digital waveform by calculation. When the peak height of this trapezoid waveform is analyzed, dead time Td will be the rise time r plus the flat top time f of the trapezoid waveform multiplied by 1.25. That is, the dead time Td can be represented in equation (1). The rise time r plus the flat top time f of the trapezoid waveform is a waveform processing time constant τ in the digital processing. The reciprocal of the dead time Td is throughput (a maximum counting rate).

Td=(r+f)×1.25 (1)

In this digital processing, a waveform processing in which a waveform processing time constant τ is approximately 0.1 μs or more can be achieved. However, in order to maintain a sufficient performance level of energy resolving power, a practical waveform processing time constant should be in a range of 0.5 to 8 μs. Throughput in this case is about 1.6 Mcps when the waveform processing time constant is 0.5 μs, and about 100 kcps when the waveform processing time constant is 8 μs.

Contrary to this digital waveform processing in the present embodiment, waveform processing in a conventional analog circuit has a long waveform processing time constant of approximately 10 to 50 μs and its dead time Td is as long as about 6.5 times that of the waveform processing time constant. Thus, in the analog circuit, when the waveform processing time constant is 10 μs, its throughput is about 15 kcps. FIG. 8 shows a relationship between a waveform processing time constant and throughput in each of the conventional analog circuit and the pulse height analyzer 15 of the digital signal processor (DSP circuit) 13 according to the present embodiment. As clearly shown in FIG. 8, the waveform processing in the digital signal processor (DSP circuit) 13 can greatly improve the throughput from the conventional analog processing circuit.

After the process of the step S2 is executed, a peak value of an inflection point of the rise waveform and the flat top waveform in the trapezoid waveform is selected (step S3). The pulse height analyzer 15 selects a digital value that is the peak value of the inflection point between the rise waveform and the flat top waveform from the digital value of each point of the trapezoid waveform obtained in Step S2. The peak value of the inflection point is a peak value at the point where the rise time r changes to the flat top time f in FIG. 7. That is, the peak value of the inflection point is equal to the peak value of the flat top time f and is the maximum peak value of the trapezoid waveform. The pulse height analyzer 15 stores the digital value of the selected inflection point peak value as the maximum peak value of the trapezoid waveform into the memory 16. The maximum peak value obtained in the step S3 corresponds to the energy of the radiation entered into the LaBr₃(Ce) scintillator 4.

The pulse height analyzer 15 performs the processes of the steps 2 and 3 to every radiation detection signal having a digital waveform inputted from the A/D converter 12, and stores the maximum peak value of the trapezoid waveform of each radiation detection signal into the memory 16.

The maximum peak values are sent to the data analysis apparatus 18 (step S4). The CPU 17 periodically reads each maximum peak value stored in the memory 16 from the memory 16 to output it to the data analysis apparatus 18. The pulse height analyzer 15 obtains the maximum peak value of the trapezoid waveform every time a radiation detection signal having a digital waveform is inputted, as described above. The cycle of the CPU 17 for reading a maximum peak value from the memory 16 and outputting it to the data analysis apparatus 18 is longer than the cycle of the pulse height analyzer 15 for obtaining the maximum peak value. Because of this, the CPU 17 outputs not only one maximum peak value but also all the maximum peak values stored into the memory 16 from the time of the previous maximum peak value output to the time of current maximum peak value output. These maximum peak values outputted from the CPU 17 are sent to the data analysis apparatus 18 through a cable.

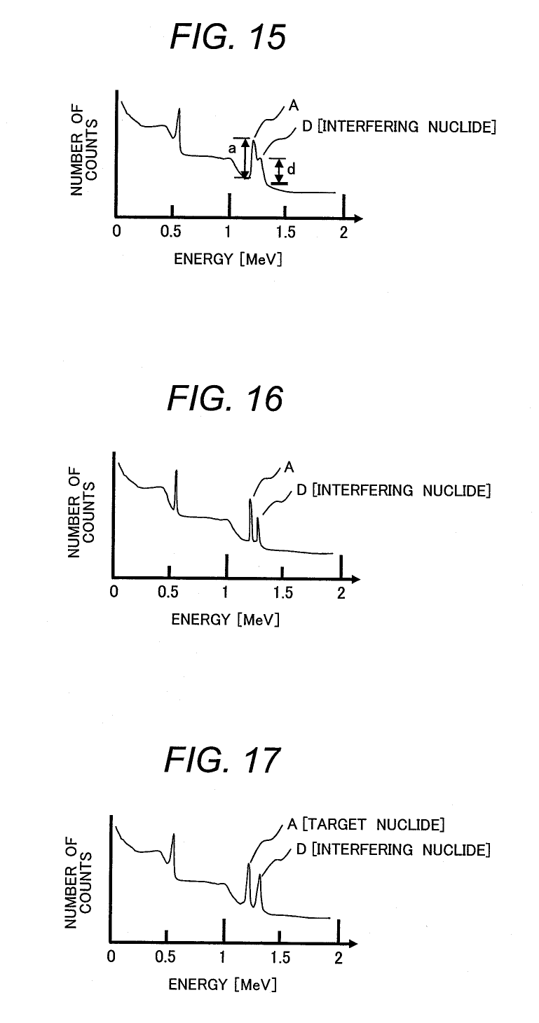

A cumulative histogram of each maximum peak value is created and a target nuclide is quantitated (step S5). The data analysis apparatus 18 creates a cumulative histogram using each maximum peak value inputted from the CPU 17. The data analysis apparatus 18 performs energy analysis using numerous maximum peak values inputted, obtains the number of count for every energy, and obtain a measurement γ ray spectrum (for example, see FIG. 15) (creating a cumulative histogram). Based on the measurement γ ray spectrum (a cumulative histogram), a target nuclide for obtaining burnup, for example, Cs-137 is quantitated, and the radiation intensity of the target nuclide (for example, Cs-137) is obtained.

After the target nuclide is quantitated, the data analysis apparatus 18 calculate burnup by converting the radiation intensity of the target nuclide (for example, Cs-137) obtained by the quantitation. The data analysis apparatus 18 outputs the calculated burnup to the display apparatus 19. Consequently, the calculated burnup is displayed on the display apparatus 19. The fuel assembly radiation measuring apparatus according to the present embodiment that obtains burnup in this way is a fuel assembly burnup measuring apparatus.

The target nuclides used for calculating burnup are Cs-137 (662 keV) and a ratio of Cs-134 (796 keV) to Cs-137 [Cs-134/Cs-137], and so on.

The conversion of the radiation intensity into burnup may be performed offline, and only the radiation intensity of the target nuclide for converting into burnup may be displayed.

In the present embodiment, since the LaBr₃(Ce) scintillator 4 is used and high speed digital waveform processing is performed, for example, at a waveform processing time constant of 0.5 μs as the process of the step S2 in the digital signal processor (DSP circuit) 13, which is a high speed waveform shaping process circuit, concretively, in the pulse height analyzer 15 of the FPGA 14, throughput is improved to 1.6 Mcps. Note that a conventional fuel assembly radiation measuring apparatus using a convention NaI(T1) scintillator as a radiation detection apparatus uses an analog circuit as a signal processing apparatus, thus the throughput is 15 kcps even when the waveform processing time constant is 10 μs. The throughput in the present embodiment is significantly improved from that of the conventional fuel assembly radiation measuring apparatus (the throughput in the present embodiment is about 100 times of that in the conventional example.) Such improvement in throughput in the present embodiment can substantially shorten the operation time of measuring the radiation of the fuel assembly 25.

Since the present embodiment uses the digital signal processor (DSP circuit) 13, that is, the pulse height analyzer 15 of the FPGA (digital waveform processing apparatus) 14 having a waveform processing time constant in a range of 0.5 to 8 μs, throughput can be improved to 100 kcps to 1.6 Mcps. For this reason, the operation time of measuring the radiation of a fuel assembly can be significantly shortened.

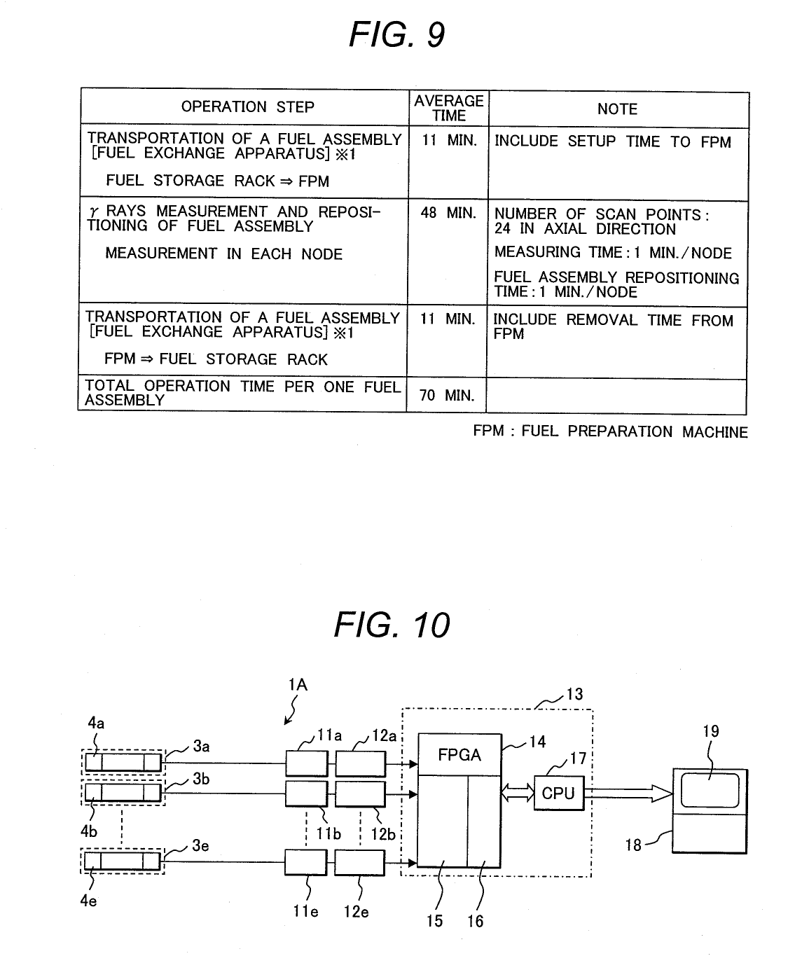

In addition, since the present embodiment uses the LaBr₃(Ce) scintillator 4, the time required for measuring the radiation of the fuel assembly 25 can be shortened. This time shortening will be described with reference to FIG. 9.

A result of analyzing the operation time required for measuring the radiation of one fuel assembly using a conventional fuel assembly radiation measuring apparatus for obtaining burnup is shown in FIG. 9. The conventional fuel assembly radiation measuring apparatus is equipped with a single NaI(T1) scintillator. The operation for measuring the radiation of the fuel assembly using the conventional fuel assembly radiation measuring apparatus includes a first stage of transporting the fuel assembly from a fuel storage rack in a fuel pool to a fuel assembly moving apparatus (FMA) in the radiation measuring area before the radiation measurement, a second stage of measuring radiation emitted from the fuel assembly using a radiation detector, and a third stage of transporting the fuel assembly from the fuel assembly moving apparatus (FMA) back to the fuel storage rack after the radiation measurement. The first stage requires 11 minutes, the second stage 48 minutes, and the third stage 11 minutes. Consequently, the total operation time required for measuring the radiation of one fuel assembly will be about 70 minutes on average.

In the second stage, the radiation (γ rays) emitted from the fuel assembly 25 is measured by a NaI(T1) scintillator. In this radiation measurement, after the radiation measurement is finished for one node, which takes one minute per node of the fuel assembly 25, the fuel assembly 25 is moved in the vertical direction (the axial direction of the fuel assembly) by the fuel assembly moving apparatus 23 for one node length to perform radiation measurement for the next node. The time required for moving one node length is one minute. Consequently, the time required for measuring the radiation of 24 nodes in the axial direction of the fuel assembly, that is, the time required for the second stage is 24 minutes for radiation measurement and 24 minutes for repositioning in the vertical direction, thus totaling 48 minutes.

In the present embodiment, since the LaBr₃(Ce) scintillator 4 is used, the time required for measuring the radiation per node of the fuel assembly 25 is shortened to 0.5 min. As a result, the time required for measuring the radiation of 24 nodes of the fuel assembly 25 in the present embodiment is 12 minutes, and is shorter than measuring the radiation of 24 nodes of the fuel assembly using the conventional fuel assembly radiation measuring apparatus.

The present embodiment, as described above, can shorten the time required for the operation of measuring the radiation of a fuel assembly.

In addition, the present embodiment can improve throughput, as described above. This leads to the prevention of count loss of radiation detection signals outputted from the LaBr₃(Ce) scintillator 4, and improves the sensitivity of the fuel assembly radiation measuring apparatus.

The light emission decay time of the LaBr₃(Ce) scintillator 4 is at least one digit shorter than that of the conventional NaI(T1) scintillator, thus the fuel assembly radiation measuring apparatus 1 using the LaBr₃(Ce) scintillator 4 can achieve measurement performance of a high counting rate. Furthermore, the performance in energy resolving power of the LaBr₃(Ce) scintillator 4 is at least twice that of the NaI(T1) scintillator. These performances are impossible to achieve in the process using the conventional analog measurement circuit, but can be achieved only by combining the above scintillator with the super high speed digital waveform processing circuit compatible with the scintillation light decay time of the scintillator. In other words, the present structure is a basic structure for solving the conventional problem.

If it becomes possible to handle a super high counting rate with this structure, it will not only easily allow the measuring apparatus to be closer to the fuel assembly that is the measurement object but also allow the weight of a shield to be reduced, which vastly downsizes the measuring apparatus.

In the fuel assembly radiation measuring apparatus of the present embodiment, a scintillator having a light emission decay time of 40 ns or less such as a LaCl₃ scintillator (light emission decay time: 28 ns), a Lu₃Al₅O₁₂ scintillator (light emission decay time: 25 ns), or a LFS scintillator (light emission decay time: 36 ns) may be used in place of the LaBr₃(Ce) scintillator 4.

When a scintillator having a light emission decay time of 40 ns or less is used such as the LaBr₃(Ce) scintillator 4, the LaCl₃ scintillator, the Lu₃Al₅O₁₂ scintillator, and the LFS scintillator and the like, it is most preferable to use a digital signal processing apparatus having a waveform processing time constant in a range of 0.5 to 2 μs as a digital waveform processing apparatus, in which case, the time required for the operation of measuring the radiation of the fuel assembly can be shortened by the most.

A fuel assembly power distribution measuring apparatus, which is a fuel assembly radiation measuring apparatus, has the same structure as the fuel assembly radiation measuring apparatus 1. The processes such as radiation measurement and signal processing performed in the fuel assembly power distribution measuring apparatus are practically the same as those performed in the fuel assembly radiation measuring apparatus 1 except for the following processes. In the step S5 performed in the fuel assembly power distribution measuring apparatus, a target nuclide for obtaining power distribution, for example, La-140 (1596 keV) is quantified based on the obtained measurement γ ray spectrum (a cumulative histogram) and the radiation intensity of the target nuclide (for example, La-140) is obtained. After the target nuclide is quantified, the data analysis apparatus 18 calculates power distribution in the fuel assembly 25 by converting the radiation intensity of the target nuclide (for example, La-140) obtained by the quantitation. The data analysis apparatus 18 outputs the calculated power distribution to the display apparatus 19. Consequently, the calculated power distribution is displayed on the display apparatus 19.

Such a fuel assembly power distribution measuring apparatus can also obtain each effect generated in the above-described fuel assembly burnup measuring apparatus (the fuel assembly radiation measuring apparatus 1) in the present embodiment.

The conversion of the radiation intensity into power distribution may be performed offline, and only the radiation intensity of the target nuclide for converting into power distribution may be displayed.

### Embodiment 2

A fuel assembly radiation measuring apparatus according to embodiment 2, which is another embodiment of the present invention, will be described with reference to FIG. 10.

A fuel assembly radiation measuring apparatus 1A of the present embodiment has a structure in which, a plurality of channels of radiation measuring apparatuses 2 is provided in the fuel assembly radiation measuring apparatus 1 of the embodiment 1. That is, the fuel assembly radiation measuring apparatus 1A has a plurality of radiation measuring apparatuses 2 having separate radiation signal generation apparatuses 3a, 3b, and 3e. In addition, the signal processing apparatus 10 has an n number of linear amplifiers 11a, 11b, and 11e, and an n number of A/D converters 12a, 12b, and 12e. A structure of each of the radiation signal generation apparatuses 3a, 3b, and 3e is as with the structure of the radiation signal generation apparatuses 3 in the embodiment 1. The post-collimator 7, the pre-collimator 8, and the absorber 9 are not shown in FIG. 10.

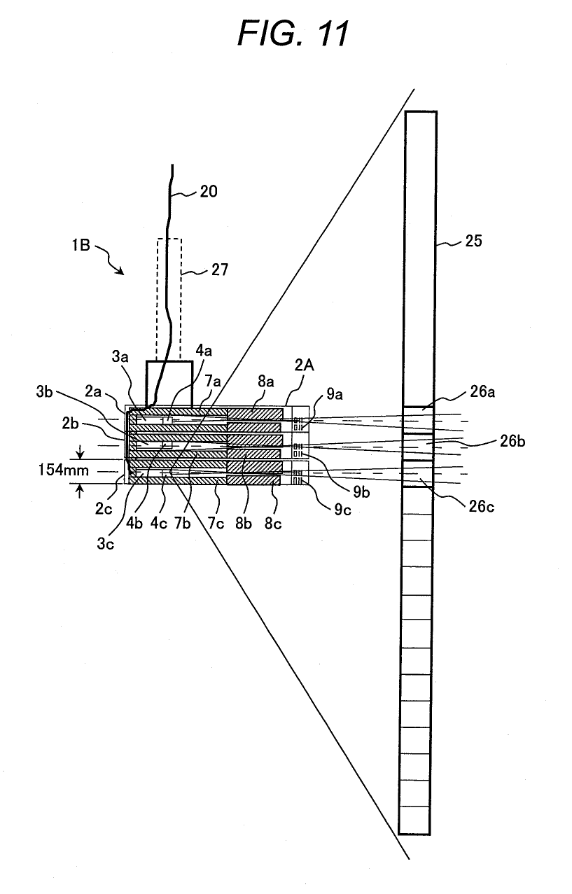

The preamplifier 6 of the radiation signal generation apparatus 3a having a LaBr₃(Ce) scintillator 4a is connected to the pulse height analyzer 15 through the linear amplifier 11a and the A/D converter 12a. The preamplifier 6 of the radiation signal generation apparatus 3b having a LaBr₃(Ce) scintillator 4b is connected to the pulse height analyzer 15 through the linear amplifier 11b and the A/D converter 12b. The preamplifier 6 of the radiation signal generation apparatus 3e having a LaBr₃(Ce) scintillator 4e is connected to the pulse height analyzer 15 through the linear amplifier 11e and the A/D converter 12e. Each preamplifier 6 of a plurality of other radiation signal generation apparatuses 3 disposed between the radiation signal generation apparatuses 3b and 3e is also connected to the pulse height analyzer 15 through the corresponding linear amplifier 11 and the A/D converter 12. The other structure of the fuel assembly radiation measuring apparatus 1A is the same as the fuel assembly radiation measuring apparatus 1. The plurality of radiation measuring apparatuses 2 are disposed parallel to each other along the vertical direction, and they are joined with each other to be one unit as a fuel assembly radiation measuring apparatus 1B shown in FIG. 11.

When the radiation of the fuel assembly 25 is measured using the fuel assembly radiation measuring apparatus 1A, in the same manner as in the embodiment 1, the fuel assembly 25 that is the measurement object is held by the fuel assembly moving apparatus 23 in the radiation measuring area in the fuel pool 33, and the plurality of radiation measuring apparatuses 2 are disposed to face the fuel assembly 25. The radiation (γ rays) emitted from each of a plurality of nodes of the fuel assembly 25 is separately measured by the LaBr₃(Ce) scintillators 4a, 4b, . . . , and 4e disposed along the vertical direction. Each of the radiation detection signals separately outputted from the LaBr₃(Ce) scintillators 4a, 4b, . . . , and 4e is inputted into the pulse height analyzer 15 through the corresponding photomultiplier tube 5, preamplifier 6, linear amplifier 11 and A/D converter 12.

The pulse height analyzer 15 sequentially performs the same processes as in the embodiment 1 to each radiation detection signal having a digital waveform inputted from each A/D converter 12, and stores each maximum peak value obtained by calculation (maximum peak value of a trapezoid waveform) into the memory 16. In this way, the pulse height analyzer 15 performs a simultaneous measurement process. The data analysis apparatus 18, in the same manner as in the embodiment 1, performs energy analysis using numerous maximum peak values inputted by the CPU 17, obtains a measurement γ ray spectrum, and obtain burnup by quantifying a target nuclide for obtaining burnup (for example, Cs-137).

The digital signal processor (DSP circuit) 13, more specifically, the pulse height analyzer 15 can be easily converted into a multichannel, and the radiation measurement process of the high counting rate described in the embodiment 1 can be performed for each radiation detection signal outputted from the radiation signal generators 3a, 3b, . . . , and 3e.

The present embodiment can obtain each effect generated in the embodiment 1. In the present embodiment, a plurality of radiation measuring apparatuses 2 can be simultaneously moved in the axial direction of the fuel assembly 25 that is the measurement object and radiation measurement can be performed to a plurality of nodes at once. Consequently, the operation time required for measuring the radiation of the fuel assembly can be further shortened than in the embodiment 1.

### Embodiment 3

A fuel assembly radiation measuring apparatus according to embodiment 3, which is another embodiment of the present invention, will be described with reference to FIG. 11.

A fuel assembly radiation measuring apparatus 1B of the present embodiment is, in the same manner as in Embodiment 2, provided with a multichannel radiation measuring apparatus 2. The fuel assembly radiation measuring apparatus 1B is different from the fuel assembly radiation measuring apparatus 1A in the embodiment 2 in a structure that it has three radiation measuring apparatuses 2, i.e. radiation measuring apparatuses 2a, 2b, and 2c. Along with this, the signal processing apparatus 10 has linear amplifiers 11a, 11b, and 11c, and A/D converters 12a, 12b, and 12c. The other structure of the fuel assembly radiation measuring apparatus 1B is the same as the fuel assembly radiation measuring apparatus 1A. The radiation measuring apparatuses 2a, 2b, and 2c are disposed along the vertical direction and joined together as one unit. These joined radiation measuring apparatuses 2a, 2b, and 2c are referred to as a multichannel radiation measuring apparatus 2A. The height of each of the radiation measuring apparatuses 2a, 2b, and 2c is 154 mm, which is the same as the height of a node (for example, a node 26a) of the fuel assembly 25.

The structure of each of the radiation measuring apparatuses 2a, 2b, and 2c is the same as that of the radiation measuring apparatus 2 used in the embodiment 1. To be more specific, the radiation measuring apparatus 2a includes a radiation signal generation apparatus 3a having a LaBr₃(Ce) scintillator 4a, a post-collimator 7a, a pre-collimator 8a, and an absorber 9a. The radiation measuring apparatus 2b includes a radiation signal generation apparatus 3b having a LaBr₃(Ce) scintillator 4b, a post-collimator 7b, a pre-collimator 8b, and an absorber 9b. The radiation measuring apparatus 2c includes a radiation signal generation apparatus 3c having a LaBr₃(Ce) scintillator 4c, a post-collimator 7c, a pre-collimator 8c, and an absorber 9c.

Although not shown in FIG. 11, the preamplifier 6 of the radiation signal generation apparatus 3a is connected to the linear amplifier 11a with the signal line 20, and connected to the pulse height analyzer 15 through the A/D converter 12a. The preamplifier 6 of the radiation signal generation apparatus 3b is connected to the linear amplifier 11b with another signal line 20 and connected to the pulse height analyzer 15 through the A/D converter 12b. The preamplifier 6 of the radiation signal generation apparatus 3c is connected to the linear amplifier 11c with yet another signal line 20 and connected to the pulse height analyzer 15 through the A/D converter 12c.

When the radiation of the fuel assembly 25 is measured using the fuel assembly radiation measuring apparatus 1B, in the same manner as in the embodiment 1, the fuel assembly 25 grasped by the fuel assembly moving apparatus 23 is disposed to the radiation measuring area in the fuel pool 33. In addition, the multichannel radiation measuring apparatus 2A hung from the hoisting and lowering apparatus 21 faces the fuel assembly 25 in the radiation measuring area. The radiation inlet (not shown) of the radiation measuring apparatus 2a faces a node 26a of the fuel assembly 25. The radiation inlet (not shown) of the radiation measuring apparatus 2b faces a node 26b of the fuel assembly 25. The radiation inlet (not shown) of the radiation measuring apparatus 2c faces a node 26c of the fuel assembly 25. The nodes 26a to 26c are three nodes continuously located along the axial direction of the fuel assembly 25. Pitches of the radiation measuring apparatuses 2a, 2b, and 2c, and pitches of the nodes of the fuel assembly 25 are all 154 mm.

The radiation (γ rays) emitted from the node 26a enters into the radiation inlet of the radiation measuring apparatus 2a and is detected by the LaBr₃(Ce) scintillator

4a. The radiation detection signal outputted from the radiation signal generation apparatus 3a of the radiation measuring apparatus 2a is inputted into the pulse height analyzer 15 through the linear amplifier 11a and the A/D converter 12a. The radiation (γ rays) emitted from the node 26b enters into the radiation inlet of the radiation measuring apparatus 2b and is detected by the LaBr₃(Ce) scintillator 4b. The radiation detection signal outputted from the radiation signal generation apparatus 3b of the radiation measuring apparatus 2b is inputted into the pulse height analyzer 15 through the linear amplifier 11b and the A/D converter 12b. The radiation (γ rays) emitted from the node 26c enters into the radiation inlet of the radiation measuring apparatus 2c and is detected by the LaBr₃(Ce) scintillator 4c. The radiation detection signal outputted from the radiation signal generation apparatus 3c of the radiation measuring apparatus 2c is inputted into the pulse height analyzer 15 through the linear amplifier 11c and the A/D converter 12c.

The A/D converters 12a, 12b, and 12c each change analog radiation detection signals into radiation detection signals having a digital waveform according to the process of the step S1. These radiation detection signals having a digital waveform are inputted into the pulse height analyzer 15. The pulse height analyzer 15 performs each process of the steps S2 and S3 to obtain a maximum peak value for each inputted radiation detection signal having a digital waveform, and stores each of the obtained maximum peak values into the memory 16. The data analysis apparatus 18 takes those maximum peak values to perform the process of the step S5 and obtains the burnup of the fuel assembly 25.

The multichannel radiation measuring apparatus 2A measures the radiation of the nodes three nodes at a time starting from the node located at the bottom of the fuel assembly 25, moving upward.

The present embodiment can obtain each effect generated in the embodiment 2. The present embodiment is provided with the multichannel radiation measuring apparatus 2A having the radiation measuring apparatuses 2a, 2b, and 2c, thus the radiation measurement of three nodes can be performed at the same time. For this reason, the present embodiment can shorten the operation time of measuring the radiation of the fuel assembly in the same manner as in the embodiment 2.

The inventors have studied the number of channels of the radiation measuring apparatuses 2 in the multichannel radiation measuring apparatus 2A. The operation of measuring the radiation of one fuel assembly using a conventional fuel assembly radiation measuring apparatus includes the first stage requiring 11 minutes, the second stage requiring 48 minutes, and third stage requiring 11 minutes as shown in FIG. 9. The first and the third stages are the transportation time of the fuel assembly 25 by the fuel exchange apparatus, thus these cannot be shortened. Even when a multichannel radiation measuring apparatus having 24-channel radiation measuring apparatuses 2 is used on a fuel assembly to measure the radiation emitted from 24 nodes at the same time, the transportation time of the fuel assembly in the first and the third stages still remains as the operation time.

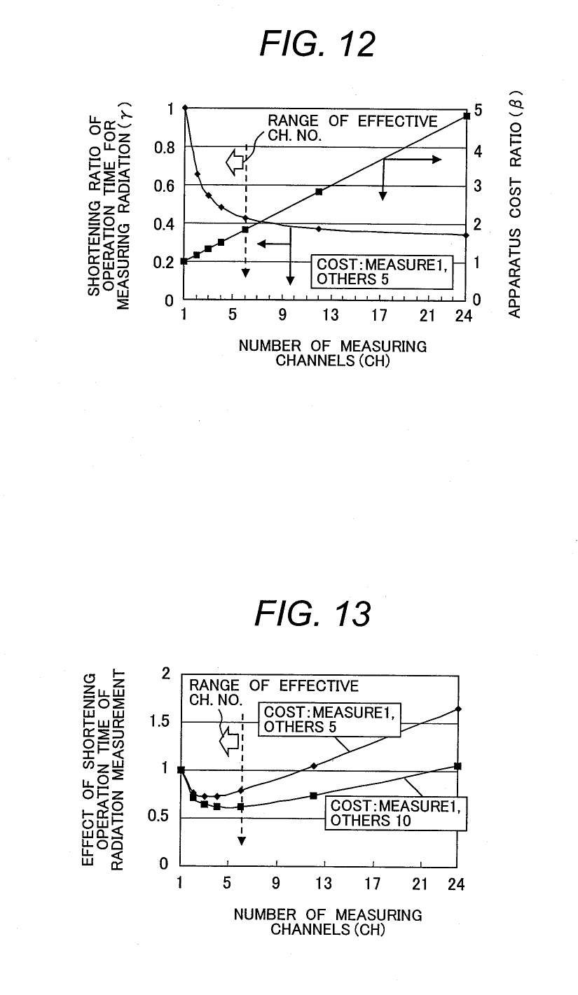

The inventors have studied a relationship between the number of channels of the radiation measuring apparatuses 2 (the number of measuring channels) included in the multichannel radiation measuring apparatus and the shortening ratio of the operation time for measuring radiation and the cost of the apparatus. A result of this is shown in FIG. 12. In FIG. 12, and FIG. 13 to be described later, “ch. no.” described in FIGS. 12 and 13 means the number of channels. In FIG. 12, the cost ratio of the fuel assembly radiation measuring apparatus is set as follows: the cost of a one-channel radiation measuring apparatus 2 in the multichannel radiation measuring apparatus is one and the cost of the part other than the multichannel radiation measuring apparatus is five. As the number of radiation measuring apparatuses 2 (the number of channels) increases, the time required for the second stage is shortened, but since the time required for the first and the third stages remains, the shortening ratio of the operation time of measuring the radiation becomes saturated. On the other hand, the apparatus cost ratio monotonically increases at a rate of the cost of the one-channel radiation measuring apparatus 2 as the number of the radiation measuring apparatuses 2 increases.

A relationship between effect of shortening the operation time of the radiation measurement and the number of channels (the number of radiation measuring apparatuses) in the multichannel radiation measuring apparatus is shown in FIG. 13. The effect of shortening the operation time of the radiation measurement shown in FIG. 13 is obtained by multiplying the shortening ratio γ of the operation time for measuring the radiation by a cost ratio β in FIG. 12, then standardizing the obtained result using a case where the number of channels is one. FIG. 13 also shows a case where the cost ratio of the fuel assembly radiation measuring apparatus is set as follows: the cost of one channel of the radiation measuring apparatus 2 in the multichannel radiation measuring apparatus is one and the cost of the part other than the multichannel radiation measuring apparatus is ten (cost: measure one, others ten).

As clearly shown in FIG. 13, the multichannel radiation measuring apparatuses provided with more than six channels of radiation measuring apparatuses 2 show a smaller effect in the shortening of the measurement operation time in consideration of the apparatus cost.

When the radiation measuring apparatus 2 in the fuel assembly radiation measuring apparatus is converted into multichannel, a number that can divide 24 (a prime factor), which is the number of nodes in the fuel assembly 25, would be an efficient and suitable number of channels. Such numbers of channels are 2, 3, 4, 6, 12, and 24, but a range of effective numbers of channels is six or less. That is, when the radiation measuring apparatus 2 in the fuel assembly radiation measuring apparatus is converted into multichannel, the number of channels should be 2, 3, 4, or 6. From this, in consideration of the simplification of the multichannel radiation measuring apparatus in the fuel assembly radiation measuring apparatus, a 2- or 3-channel structure will be most effective.

### Embodiment 4

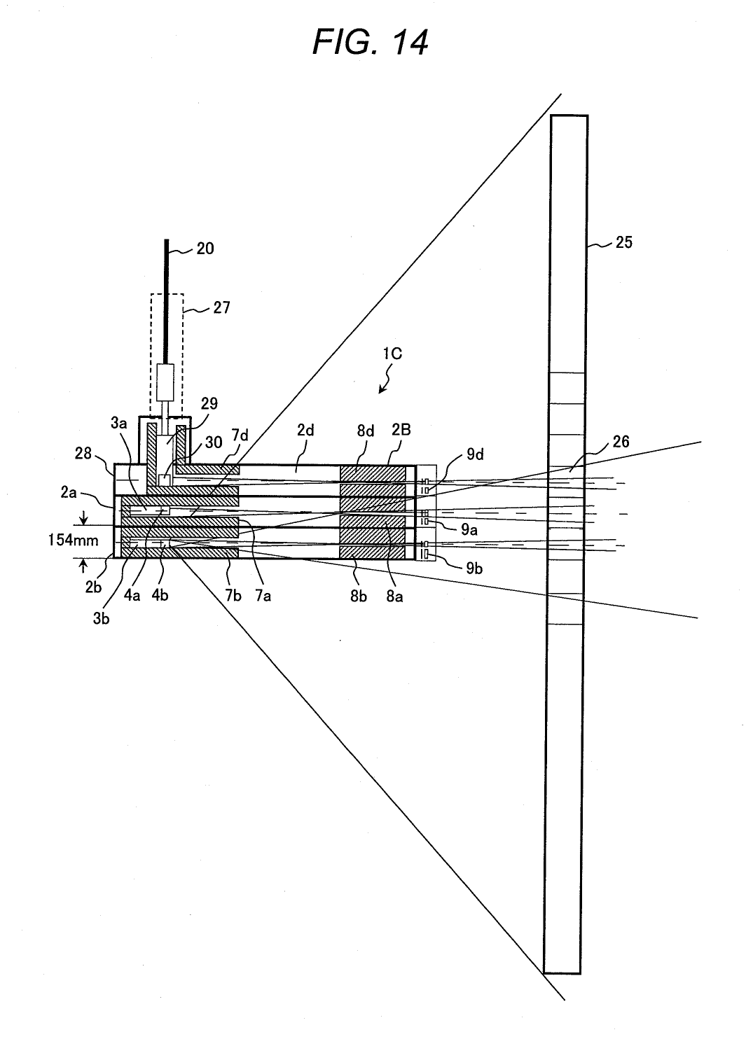

A fuel assembly radiation measuring apparatus according to embodiment 4, which is another embodiment of the present invention, will be described with reference to FIG. 14. A fuel assembly radiation measuring apparatus 10 of the present embodiment has a structure in which, the multichannel radiation measuring apparatus 2A in the fuel assembly radiation measuring apparatus 1B in the embodiment 3 is replaced with a multichannel radiation measuring apparatus 2B. The other structure of the fuel assembly radiation measuring apparatus 10 is the same as the fuel assembly radiation measuring apparatus 1B.

The multichannel radiation measuring apparatus 2B has two channels of radiation measuring apparatuses 2, i.e. the radiation measuring apparatuses 2a and 2b, and one channel of a radiation measuring apparatus 2d; the radiation measuring apparatuses 2a, 2b, and 2d are joined together as one unit. The radiation measuring apparatus 2a has the radiation signal generation apparatus 3a that includes the LaBr₃(Ce) scintillator 4a. The radiation measuring apparatus 2b has the radiation signal generation apparatus 3b that includes the LaBr₃(Ce) scintillator 4b. The radiation measuring apparatus 2d has a radiation signal generator 29 which includes a Ge(Li) radiation detector 30. The Ge(Li) radiation detector 30 is a semiconductor radiation detector, and its energy resolving power in γ ray measurement is at least one digit better than scintillators such as the LaBr₃(Ce) scintillator 4, etc. The radiation signal generator 29 includes the Ge(Li) radiation detector 30 and the preamplifier 6 (not shown) connected to the Ge(Li) radiation detector 30. The height of each of the radiation measuring apparatuses 2a, 2b, and 2d is 154 mm, and they are disposed along the vertical direction at a pitch of 154 mm.

The signal processing apparatus 10 of the fuel assembly radiation measuring apparatus 10 has, although not shown in the FIG., linear amplifiers 11a, 11b, and 11d, and A/D converters 12a and 12b. The preamplifier 6 of the radiation signal generation apparatus 3a is, in the same manner as in the embodiment 3, connected to the pulse height analyzer 15 through the linear amplifier 11a and the A/D converter 12a. The preamplifier 6 of the radiation signal generation apparatus 3b is, in the same manner as in the embodiment 3, connected to the pulse height analyzer 15 through the linear amplifier 11b and the A/D converter 12b. The preamplifier 6 of the radiation signal generator 29 is connected to the pulse height analyzer 15 through the linear amplifier 11d with a single signal cable 20.

When the radiation of the fuel assembly 25 is measured using the fuel assembly radiation measuring apparatus 1C, in the same manner as in the embodiment 3, the fuel assembly 25 is disposed in the radiation measuring area in the fuel pool 33 by the fuel assembly moving, apparatus 23. Furthermore, each of the radiation measuring apparatuses 2d, 2a, and 2b of the multichannel radiation measuring apparatus 2B hung from the hoisting and lowering apparatus 21 is facing a different node 26 of the fuel assembly 25 in the radiation measuring area. These three nodes 26 are continuously located along the axial direction of the fuel assembly 25. The pitches of the radiation measuring apparatuses 2d, 2a, and 2b, and the pitches of the nodes of the fuel assembly 25 are all 154 mm.

According to the processes of the steps S2 and S3, the pulse height analyzer 15 obtains the maximum peak values of every radiation detection signal having a digital waveform inputted from each of the A/D converters 12a and 12b (the radiation detected by the LaBr₃(Ce) scintillators 4a and 4b). These maximum peak values are stored in the memory 16. The radiation detection signals (digital signals) outputted from the Ge(Li) radiation detection apparatus 30 are amplified in the preamplifier 6 and the linear amplifier 11d, and inputted into the pulse height analyzer 15. The peak value (the maximum peak value) of each radiation detection signal outputted from the Ge(Li) radiation detector 30 is obtained by the pulse height analyzer 15 using a known method. The maximum peak value of each radiation detection signal outputted from the Ge(Li) radiation detector 30 is also stored in the memory 16.

The data analysis apparatus 18 performs the process of the step S5. In this process, the data analysis apparatus 18 performs energy analysis using numerous maximum peak values obtained from every radiation detection signal generated by the LaBr₃(Ce) scintillators 4a and 4b on the detection of radiation, and obtains a first measurement γ ray spectrum shown in FIG. 15 (creating a first cumulative histogram). In addition, the data analysis apparatus 18 performs frequency analysis using the numerous maximum peak values obtained from radiation detection signals generated by the Ge(Li) radiation detector 30 on the detection of radiation, and obtains a second measurement γ ray spectrum shown in FIG. 16 (creating a second cumulative histogram).

In the first measurement γ ray spectrum, a target nuclide A (for example, Cs-137) for obtaining burnup and an interfering nuclide D are so close to each other that part of their peak areas overlaps with the other. When the γ ray energy of the interfering nuclide D is too close to the γ ray energy of the target nuclide A in such a way, the target nuclide A cannot be accurately quantified in the first measurement γ ray spectrum (FIG. 15). However, in the second measurement γ ray spectrum, since the peak areas of the target nuclide A (for example, Cs-137) and the interfering nuclide D are apart, the data analysis apparatus 18 can accurately quantify the target nuclide A based on the second measurement γ ray spectrum, that is, the γ ray energy of the target nuclide A and the interfering nuclide D based on the γ ray energy of the interfering nuclide D. The target nuclide A and the interfering nuclide D can each be quantified accurately in the second measurement γ ray spectrum (FIG. 16) because the energy resolving power of the Ge(Li) radiation detector 30 is at least one digit better than the LaBr₃(Ce) scintillator 4.

Next, a correction apparatus for correcting effect of an interfering nuclide will be described. First of all, the data analysis apparatus 18 obtains the net count S_{A} of the target nuclide A (a value where the background count is subtracted from the count of the γ ray energy of the target nuclide A) based on the second measurement γ ray spectrum measured by the Ge(Li) detector 30 (FIG. 16). Then, the peak height Pa of the target nuclide A (a value where the background height is subtracted from the peak height of the target nuclide A) is obtained based on the first measurement γ ray spectrum by the LaBr₃ detector 4 (FIG. 15) measured under the same condition. From these measurements, the net count Sa of the peak height Pa of the target nuclide A in the first measurement γ ray spectrum can be obtained as the net count S_{A} of the target nuclide A in the second measurement γ ray spectrum. However, Sa is a value from the LaBr₃ detector so that a correction such as detection efficiency (f) with respect to the Ge(Li) detector is necessary [Sa(Pa)=f×S_{A}].

If this correction data is obtained, the net count Sa of the target nuclide A from which, the interfering nuclide is corrected in the measurement γ ray spectrum by the LaBr₃ detector separately and individually measured, can be obtained by proportional calculation using a ratio ((Pa)′/(Pa)) of the peak height (Pa)′ of the target nuclide A in the measurement γ ray spectrum by the LaBr₃ detector separately and individually measured to the peak height (Pa) after the correction.

The information data analysis apparatus 18 quantifies the net count of the target nuclide A by making a correction with respect to the above-described interfering nuclide, and calculates burnup by converting the radiation intensity of Cs-137, for example.

Now, assume that the first measurement γ ray spectrum shown in FIG. 17 is obtained in the process of the step S5 performed by the data analysis apparatus 18. In this first measurement γ ray spectrum, the peak areas of the target nuclide A and the interfering nuclide D are separated. Therefore the target nuclide A can be accurately quantified based on the first measurement γ ray spectrum. In this case, the quantitation of the target nuclide A does not require any correction using the information obtained based on the second measurement γ ray spectrum as in the first measurement γ ray spectrum shown in FIG. 15.

The data analysis apparatus 18 determines whether the interfering nuclide in the first measurement γ ray spectrum is too close to the target nuclide as in FIG. 15 or is far enough away as in FIG. 17 in the following way. The data analysis apparatus 18 calculates a peak width of the target nuclide and when the peak width is the width of a given energy resolving power, it is determined as a regular single peak, but when the peak width is over the given energy resolving power width, it is determined as a compound peak of a plurality of nuclides.

In the present embodiment also, the multichannel radiation measuring apparatus 2B measures the radiation of nodes three nodes at a time starting from the node located at the bottom of the fuel assembly 25, moving upward.

The present embodiment can obtain each effect generated in the embodiment 3. Furthermore in the present embodiment, the quantified value of the target nuclide A in the first measurement γ ray spectrum obtained based on the radiation detection signals generated by the LaBr₃(Ce) scintillator on the detection of radiation is corrected using the quantified value of the target nuclide A in the second measurement γ ray spectrum obtained based on the radiation detection signals detected by the Ge(Li) radiation detector 30 which is a semiconductor radiation detector. For this reason, even when there is an interfering nuclide D having a γ ray energy too close to the γ ray energy of the target nuclide A, causing the radiation detection signals generated by the LaBr₃(Ce) scintillator on the detection of radiation to be unanalyzable (a case where a compound spectrum appears due to close γ ray energies), the target nuclide A can be accurately quantified in the present embodiment. Therefore, even in a case of a compound spectrum, the burnup of the fuel assembly 25 can be accurately obtained.

When data from the Ge(Li) radiation detector 30 for correcting the quantified value of the target nuclide A are accumulated, the radiation measuring apparatus 2d including the Ge(Li) radiation detector 30 is detached from the multichannel radiation measuring apparatus 2B, and radiation measurement is performed on each node of the fuel assembly 25 using the multichannel radiation measuring apparatus 2B having the radiation measuring apparatuses 2a and 2b including the LaBr₃(Ce) scintillator 4. In this case, the Ge(Li) radiation detector 30 is removably installed to the multichannel radiation measuring apparatus 2B.

In the embodiment 1, the second measurement γ ray spectrum can be obtained in the same manner as in the present embodiment by installing the radiation measuring apparatus 2d including the Ge(Li) radiation detector 30 to the radiation measuring apparatus 2, so that when a compound spectrum appears in the first measurement γ ray spectrum, the target nuclide A can be accurately quantified from the first measurement γ ray spectrum. Instead of the Ge(Li) radiation detector, a semiconductor radiation detector such as a CdTe radiation detection apparatus may be used.

### Embodiment 5

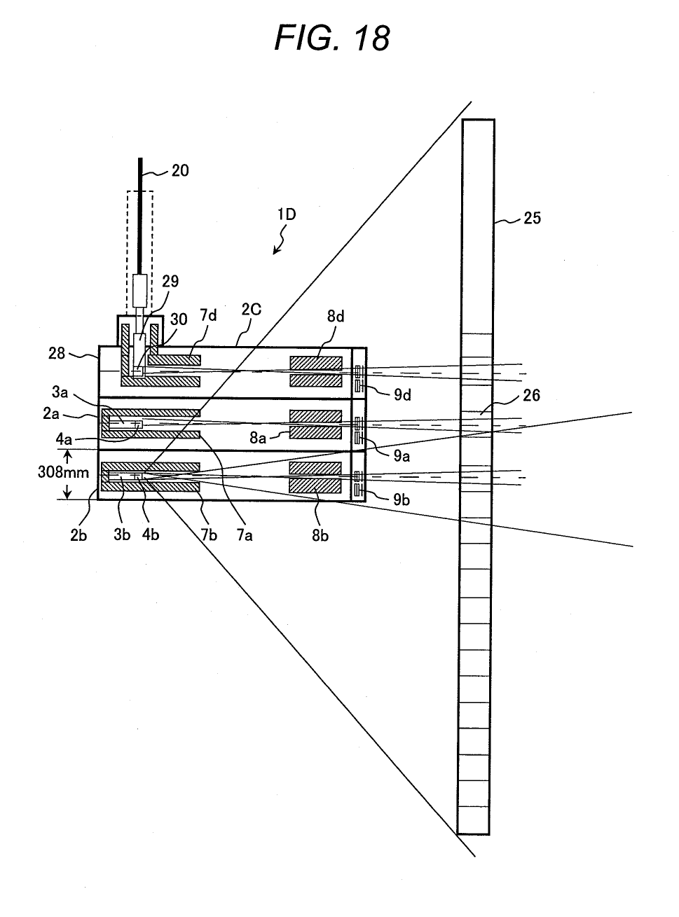

A fuel assembly radiation measuring apparatus according to embodiment 5, which is another embodiment of the present invention, will be described with reference to FIG. 18.

A fuel assembly radiation measuring apparatus 1D of the present embodiment has a structure in which, the multichannel radiation measuring apparatus 2B in the fuel assembly radiation measuring apparatus 10 in the embodiment 4 is replaced with a multichannel radiation measuring apparatus 2C. The other structure of the fuel assembly radiation measuring apparatus 1D is the same as the fuel assembly radiation measuring apparatus 10.

The multichannel radiation measuring apparatus 2C has the same structure as the multichannel radiation measuring apparatus 2B except that the height of each of the radiation measuring apparatuses 2a, 2b, and 2d is 308 mm in the multichannel radiation measuring apparatus 2C. The multichannel radiation measuring apparatus 2C and the multichannel radiation measuring apparatus 2B are different only in the height of the radiation measuring apparatuses 2a, 2b, and 2d. In the multichannel radiation measuring apparatus 2C, the radiation measuring apparatuses 2a, 2b, and 2d are disposed at a pitch of 308 mm; this pitch is twice as large as the pitch of the node 26 (154 mm) of the fuel assembly 25.

When the radiation of the fuel assembly 25 is measured using the fuel assembly radiation measuring apparatus 1D, in the same manner as in the embodiment 3, the fuel assembly 25 is disposed in the radiation measuring area in the fuel pool 33 by the fuel assembly moving apparatus 23. The radiation measuring apparatuses 2d, 2a, and 2b of the multichannel radiation measuring apparatus 2C hung from the hoisting and lowering apparatus 21 are separately facing three nodes 26 of the fuel assembly 25 in the radiation measuring area. These three nodes 26 are located every other node along the axial direction of the fuel assembly 25.

In the present embodiment, the signal processing apparatus 10 performs the same processes as in the embodiment 4.

The present embodiment can obtain each effect generated in the embodiment 4.

As in the present embodiment, changing the pitch of a radiation measuring apparatus from the pitch of a node (for example, make the former pitch twice that of the latter pitch) is applicable to the pitches of the radiation measuring apparatuses 2a, 2b, and 2c in the embodiment 3.

In the same manner as in the embodiment 1, the embodiments 2 to 5 also are applicable to the fuel assembly power distribution measuring apparatus which is a fuel assembly burnup measuring apparatus.

The embodiments 1 to 5 can be used when the radioactive concentration of the fuel assembly used in a boiling water reactor and a pressurized water reactor is measured.

### INDUSTRIAL APPLICABILITY

The present invention can be used for measuring the radioactive concentration of a fuel assembly used in a reactor such as a boiling water reactor and a pressurized water reactor.

### REFERENCE SIGNS LIST

1, 1A, 1B, 1C, 1D: fuel assembly radiation measuring apparatus, 2, 2a, 2b, 2c, 2d, 2e, 28: radiation measuring apparatus, 2A, 2B, 2C: multichannel radiation measuring apparatus, 3, 3a, 3b, 3c, 29: radiation signal generation apparatus, 4, 4a, 4b, 4c, 4e: LaBr₃(Ce) scintillator, 5: photomultiplier tube, 6: preamplifier, 7: post-collimator, 8: pre-collimator, 9: absorber, 10: signal processing apparatus, 12, 12a, 12b, 12c, 12e: analog/digital converter, 13: digital signal processor, 14: field-programmable gate array (FPGA), 15: pulse height analyzer, 17: central processing unit, 18: data analysis apparatus, 21: hoisting and lowering apparatus, 23: fuel assembly moving apparatus, 25: fuel assembly, 26, 26a, 26b, 26c: node, 30: Ge(Li) radiation detector, 32: casing.

What is claimed is:

1. A fuel assembly radiation measuring apparatus comprising:
a first radiation measuring apparatus including a first collimator for limiting radiation emitted from a fuel assembly, a scintillator having a light emission decay time of 40 ns or less and detecting the radiation passed through the first collimator, a signal generation apparatus for generating a first radiation detection signal that is an electric signal, based on light emitted from the scintillator by the radiation entry, and a casing in which the first collimator, scintillator and signal generation apparatus are disposed;
a signal changing apparatus for changing the first radiation detection signal outputted from the signal generation apparatus into a radiation detection signal having a digital waveform;
a digital waveform processing apparatus for obtaining a first maximum peak value for every said radiation detection signal having a digital waveform outputted from the signal changing apparatus; and
a data analysis apparatus for quantifying a target nuclide using a plurality of the first maximum peak values obtained by the digital waveform processing apparatus.

2. The fuel assembly radiation measuring apparatus according to claim 1, comprising:
the digital waveform processing apparatus having a waveform processing time constant in a range of 0.5 to 8 μs.

3. The fuel assembly radiation measuring apparatus according to claim 2, comprising:
the digital waveform processing apparatus having a waveform processing time constant in a range of 0.5 to 2 μs.

4. The fuel assembly radiation measuring apparatus according to claim 1, comprising:
a second radiation measuring apparatus including a second collimator for limiting the radiation emitted from the fuel assembly and a semiconductor radiation detection apparatus for detecting the radiation passed through the second collimator, both disposed in another casing,
and the digital waveform processing apparatus for obtaining a second maximum peak value for every second radiation detection signal outputted from the semiconductor radiation detection apparatus.

5. The fuel assembly radiation measuring apparatus according to claim 4,
the data analysis apparatus for correcting the quantified value of the target nuclide obtained using the plurality of first maximum peak values by using information showing a relationship between the target nuclide and an interfering nuclide obtained using a plurality of the second maximum peak values when the target nuclide cannot be quantified by using the plurality of first maximum peak values due to influence of the interfering nuclide.

6. The fuel assembly radiation measuring apparatus according to claim 1,
wherein the number of the first radiation measuring apparatuses is two, three, four, or six.

7. The fuel assembly radiation measuring apparatus according to claim 6,
wherein a pitch for disposing the first radiation measuring apparatuses in the axial direction of the fuel assembly is equal to either the pitch of a node of the fuel assembly or a multiple of the pitch of the node.

8. The fuel assembly radiation measuring apparatus according to claim 1,
wherein the scintillator is any one of a LaBr₃(Ce) scintillator, a LaCl₃ scintillator, a Lu₃Al₅O₁₂ scintillator, and a LFS scintillator.

9. The fuel assembly radiation measuring apparatus according to claim 4,
wherein the second radiation measuring apparatus is removably installed to the first radiation measuring apparatus.

10. The fuel assembly radiation measuring apparatus according to claim 4,
wherein a pitch for disposing a plurality of radiation measuring apparatuses including the first radiation measuring apparatus and the second radiation measuring apparatus is equal to either the pitch of a node of the fuel assembly or a multiple of the pitch of the node.

11. A method for measuring radiation of a fuel assembly, comprising steps of:
entering the radiation emitted from the fuel assembly that is a measurement object into a scintillator having a light emission decay time of 40 ns or less;
generating a first radiation detection signal that is an electric signal, based on light emitted from the scintillator by the radiation entry;
changing the first radiation detection signal into a radiation detection signal having a digital waveform;
obtaining a first maximum peak value for every the radiation detection signal having a digital waveform using a digital waveform processing apparatus; and
quantifying a target nuclide using a plurality of the first maximum peak values obtained by the digital waveform processing apparatus.

12. The method for measuring the radiation of the fuel assembly according to claim 11, comprising steps of:
measuring the radiation emitted from the fuel assembly using a semiconductor radiation detection apparatus;
obtaining a second maximum peak value for every second radiation detection signal outputted from the semiconductor radiation detection apparatus, using the digital waveform processing apparatus; and
correcting the quantified value of a target nuclide obtained using the plurality of first maximum peak values by using information showing a relationship between the target nuclide and an interfering nuclide obtained using a plurality of the second maximum peak values when the target nuclide cannot be quantified by using the plurality of first maximum peak values due to the influence of the interfering nuclide.
